(19) United States
(12) Patent Application Publication
(10) Pub. No.: US 2015/0345674 A1
(43) Pub. Date: Dec. 3, 2015

(54) Connector Having A Tubular Inner Surface Barb

(71) Applicant: Eldon James Corp., Denver, CO (US)

(72) Inventors: William A. Coulson, Fort Collins, CO (US); Marcia Coulson, Fort Collins, CO (US); Paul Ciccone, Social Circle, GA (US); Chene L. Cramer, Longmont, CO (US)

(73) Assignee: Eldon James Corp., Denver, CO (US)

(21) Appl. No.: 14/728,299

(22) Filed: Jun. 2, 2015

Related U.S. Application Data
(60) Provisional application No. 62/006,719, filed on Jun. 2, 2014.

(51) Int. Cl. F16L 21/00

(52) U.S. Cl. CPC F16L 21/002

(57) ABSTRACT

A connector including a tubular inner surface defining a connector passageway which communicates between connector first and second open ends; and a barb inwardly extending from the tubular inner surface into the connector passageway proximate the connector first open end, the barb terminating in a barb tip which disposes away from the connector first open end. The barb tip is configured to engage with a conduit external surface of a conduit inserted into the connector first open end for receipt within the connector passageway. As to particular embodiments, the tubular inner surface and the barb can be formed as a one-piece construct.

This United States Non-Provisional Patent Application claims the benefit of U.S. Provisional Patent Application No. 62/006,719, filed Jun. 2, 2014, hereby incorporated by reference herein.

### I. SUMMARY OF THE INVENTION

A broad object of a particular embodiment of the invention can be to provide a connector including a tubular inner surface defining a connector passageway which communicates between connector first and second open ends; and a barb inwardly extending from the tubular inner surface into the connector passageway proximate the connector first open end, the barb terminating in a barb tip which disposes away from the connector first open end. The barb tip is configured to engage with a conduit external surface of a conduit inserted into the connector first open end for receipt within the connector passageway.

Another broad object of a particular embodiment of the invention can be to provide the connector having the tubular inner surface and the barb formed as a one-piece construct.

Another broad object of a particular embodiment of the invention can be to provide a method of making a connector, the method including providing a tubular inner surface defining a connector passageway which communicates between connector first and second open ends; inwardly extending a barb from the tubular inner surface into the connector passageway proximate the connector first open end, the barb terminating in a barb tip; and disposing the barb tip away from the connector first open end. The barb tip is configured to engage with a conduit external surface of a conduit inserted into the connector first open end for receipt within the connector passageway.

Another broad object of a particular embodiment of the invention can be to provide a method of making the connector by forming the tubular inner surface and the barb as a one-piece construct.

Another broad object of a particular embodiment of the invention can be to provide a method of using a connector to connect to a conduit, the method including obtaining the connector comprising: a tubular inner surface defining a connector passageway which communicates between connector first and second open ends; and a barb inwardly extending from the tubular inner surface into the connector passageway proximate the connector first open end, the barb terminating in a barb tip which disposes away from the connector first open end; and fixedly securing the conduit within the connector passageway.

Naturally, further objects of the invention are disclosed throughout other areas of the specification, drawings, and claims.

### II. A BRIEF DESCRIPTION OF THE DRAWINGS

FIG. 1 illustrates a method of using a particular embodiment of the connector to couple an apparatus to a conduit, allowing fluid to flow through a fluid flow path between an apparatus interior space and a conduit passageway.

FIG. 2A is a perspective view of a particular embodiment of the connector having a conduit received within a connector passageway, the connector having a plurality of discrete barbs disposed in circumferentially spaced apart relation about a tubular inner surface.

FIG. 2B is a cross sectional view 2B-2B of the particular embodiment of the connector shown in FIG. 2A.

FIG. 2C is an enlarged view of the particular embodiment of the connector shown in FIG. 2B.

FIG. 2D is a first end view of a particular embodiment of the connector having a plurality of discrete barbs disposed in circumferentially spaced apart relation about a tubular inner surface.

FIG. 2E is a cross sectional view 2E-2E of the particular embodiment of the connector shown in FIG. 2D.

FIG. 3A is a perspective view of a particular embodiment of the connector having a conduit received within a connector passageway, the connector having a barb configured as an annular barb circumferentially extending about a tubular inner surface.

FIG. 3B is a cross sectional view 3B-3B of the particular embodiment of the connector shown in FIG. 3A.

FIG. 3C is an enlarged view of the particular embodiment of the connector shown in FIG. 3B.

FIG. 3D is a cross sectional view of the particular embodiment of the connector shown in FIG. 3A.

FIG. 3E is a first end view of a particular embodiment of the connector having a barb configured as an annular barb circumferentially extending about a tubular inner surface.

FIG. 3F is a cross sectional view 3F-3F of the particular embodiment of the connector shown in FIG. 3E.

FIG. 4A is a perspective view of a particular embodiment of the connector having a conduit received within a connector passageway, the connector having a barb configured as a helical barb helically extending about a tubular inner surface.

FIG. 4B is a cross sectional view 4B-4B of the particular embodiment of the connector shown in FIG. 4A.

FIG. 4C is an enlarged view of the particular embodiment of the connector shown in FIG. 4B.

FIG. 4D is a first end view of a particular embodiment of the connector having a barb configured as a helical barb helically extending about a tubular inner surface.

FIG. 4E is a cross sectional view 4E-4E of the particular embodiment of the connector shown in FIG. 4D.

FIG. 5A is a perspective view of a particular embodiment of the connector having a conduit received within a connector passageway, the connector having a barb configured as a couplable barb capable of coupling to the connector.

FIG. 5B is a cross sectional view 5B-5B of the particular embodiment of the connector shown in FIG. 5A.

FIG. 5C is a first end view of a particular embodiment of the connector having a barb configured as a couplable barb capable of coupling to the connector.

FIG. 5D is a cross sectional view 5D-5D of the particular embodiment of the connector shown in FIG. 5C.

FIG. 5E is a first side view of a particular embodiment of the connector having a barb configured as a couplable barb capable of coupling to the connector.

FIG. 5F is a cross sectional view 5F-5F of the particular embodiment of the connector shown in FIG. 5E.

FIG. 6 is a cross sectional view of a particular embodiment of a mold useful for forming the connector as a one-piece construct.

FIG. 7A is an illustration of a method of making a particular embodiment of the connector as a one-piece construct by injection molding.

FIG. 7B is an illustration of a method of making a particular embodiment of the connector as a one-piece construct by injection molding.

### III. DETAILED DESCRIPTION OF THE PREFERRED EMBODIMENTS

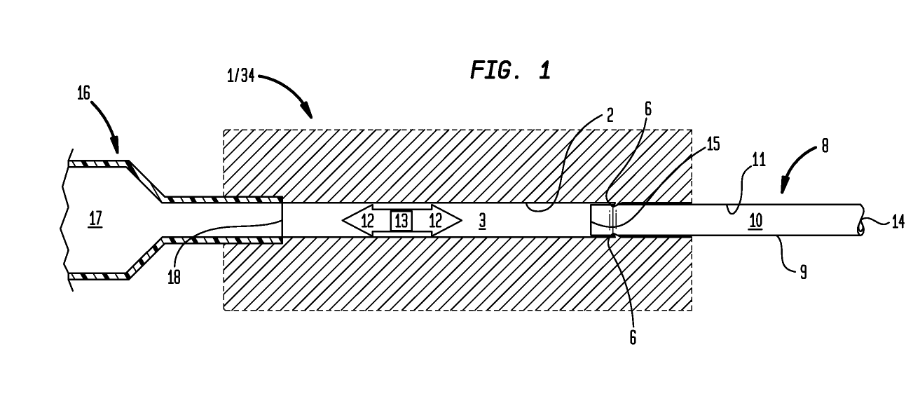

Now referring primarily to FIG. 1, which illustrates a method of using a particular embodiment of a connector (1) including a tubular inner surface (2) which defines a connector passageway (3) communicating between connector first and second open ends (4)(5). The connector (1) further includes a barb (6) inwardly extending from the tubular inner surface (2) into the connector passageway (3) proximate the connector first open end (4), whereby the barb (6) terminates in a barb tip (7) which disposes away from the connector first open end (4).

Again referring primarily to FIG. 1, the method of using the connector (1) includes fixedly securing a conduit (8) within the connector passageway (3) by inserting the conduit (8) into the connector first open end (4) and passing the conduit (8) through a portion of the connector passageway (3) to engage a conduit external surface (9) with the barb tip (7), whereby engagement of the conduit external surface (9) with the barb tip (7) fixedly secures the conduit (8) within the connector passageway (3), precluding the conduit (8) from egressing from the connector first open end (4) of the connector (1).

Upon fixed securement of the conduit (8) within the connector passageway (3), a conduit passageway (10) defined by a conduit internal surface (11) fluidicly couples to the connector passageway (10) to provide a first portion of a fluid flow path (12). Accordingly, the method of using the connector (1) can, but need not necessarily, further include flowing fluid (13) through the fluid flow path (12).

The term “conduit” for the purposes of the present invention means a tubular member, usually but not necessarily of circular cross section, having a wall thickness, usually but not necessarily uniform in thickness, disposed between a conduit external surface (9) and a conduit internal surface (11) which defines a conduit passageway (10) extending between conduit first and second open ends (14)(15).

A conduit (8) can be formed from a polymeric material, which can include as non-limiting examples: thermoplastic elastomers such as styrene block copolymers, polyolefin blends, elastomeric alloys, thermoplastic polyurethanes, thermoplastic copolyester, thermoplastic polyamides; polypropylene, polyethylene, high density polyethylene, low density polyethylene, polyvinylidene fluoride, acrylonitrile butadiene styrene, polyvinylchloride, polyether block amide, thermoplastic elastomer (TPE), or the like, or combinations thereof.

Again referring primarily to FIG. 1, the method of using the connector (1) can, but need not necessarily, further include coupling an apparatus (16) having an apparatus interior space (17) which communicates with an apparatus open end (18) to the connector (1) proximate the connector second open end (5), thereby fluidicly coupling the apparatus interior space (17) to the connector passageway (3) to provide a second portion of the fluid flow path (12). Following, the method of using the connector (1) can, but need not necessarily, further include flowing fluid (13) through the fluid flow path (12). In this way, the connector (1) can couple the apparatus (16) to the conduit (8), allowing fluid (13) to flow through the fluid flow path (12) between the apparatus interior space (17) and the conduit passageway (10).

The term “apparatus” for the purposes of the present invention means a device, usually but not necessarily a medical device, which can be coupled to the connector (1) proximate the connector second open end (5).

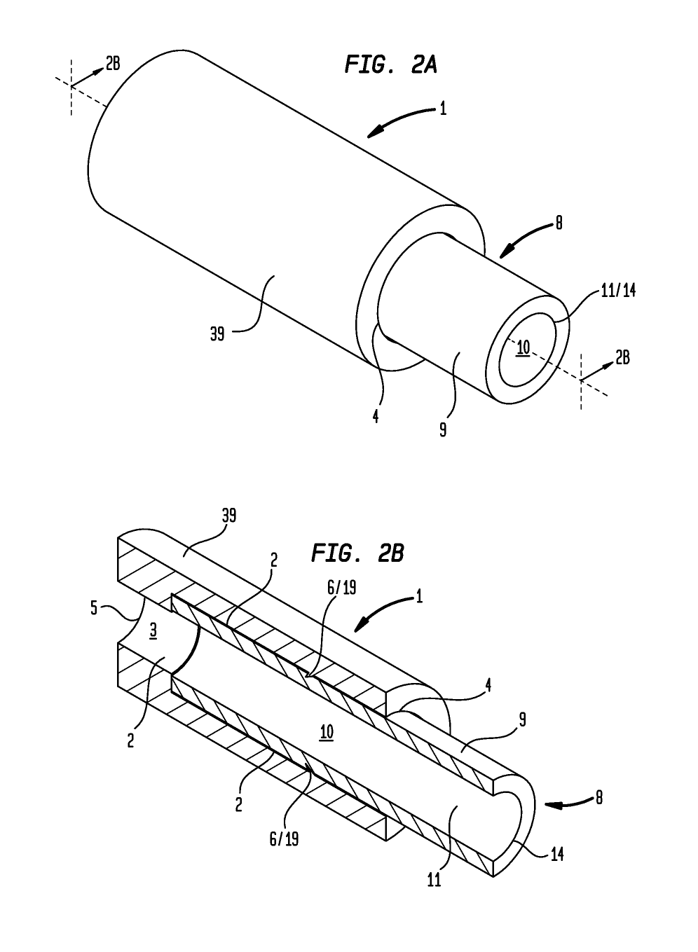

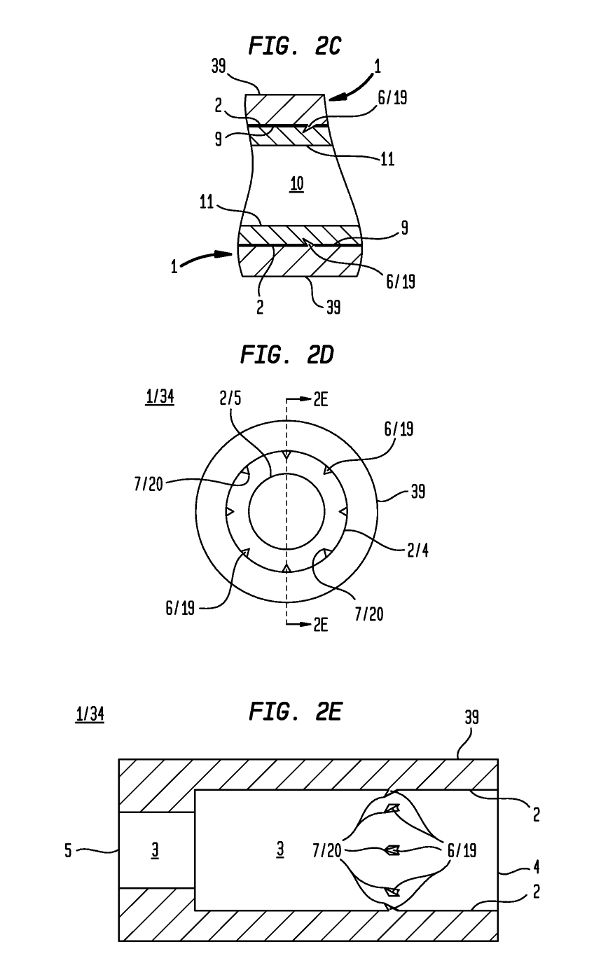

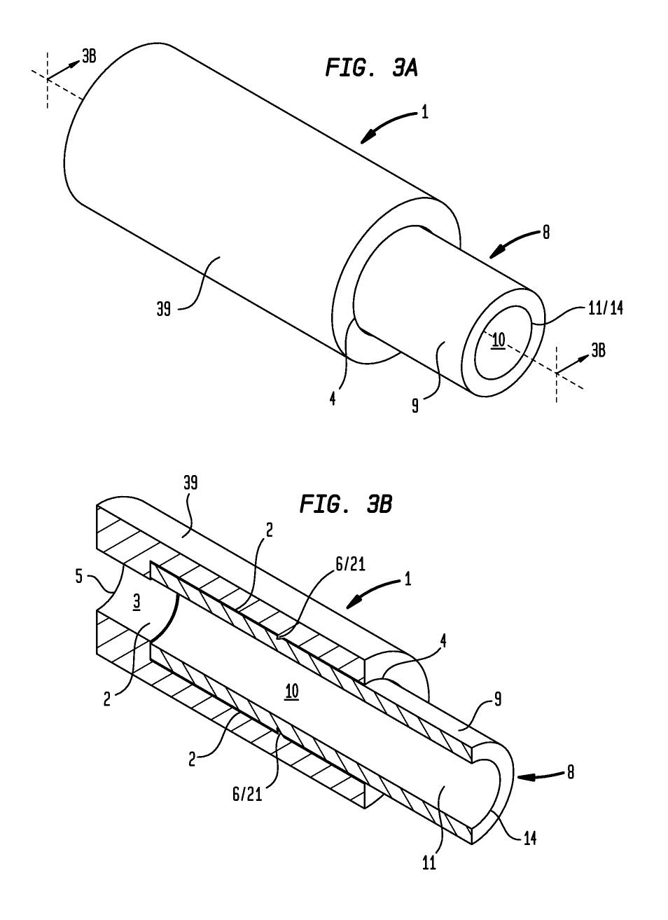

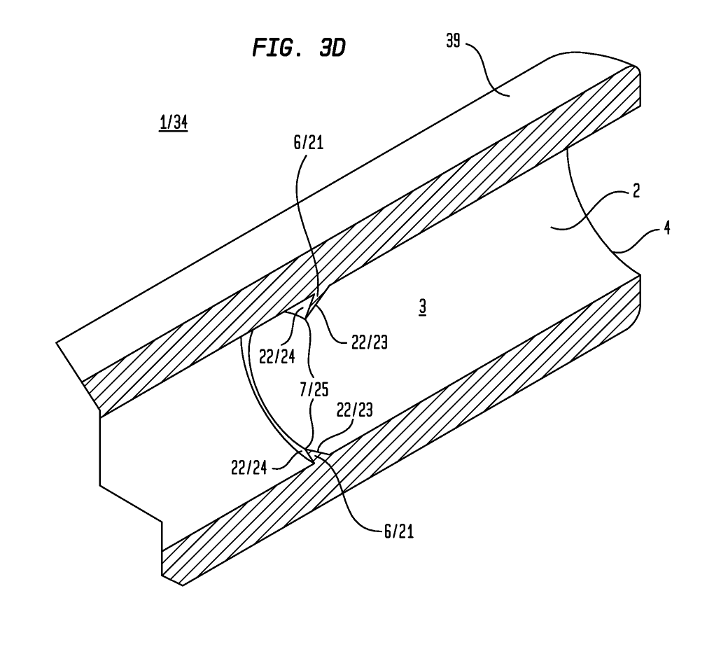

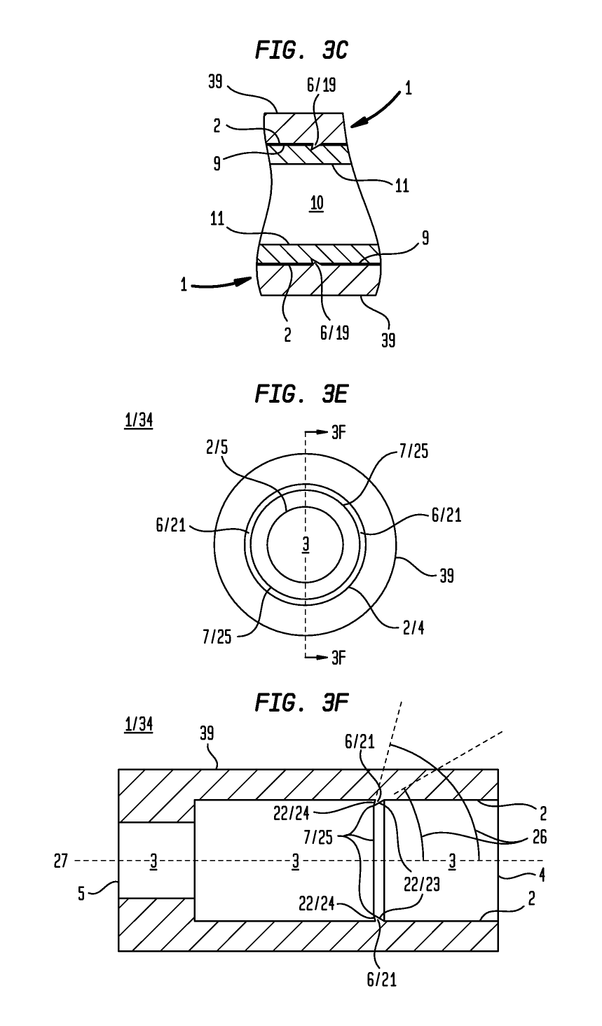

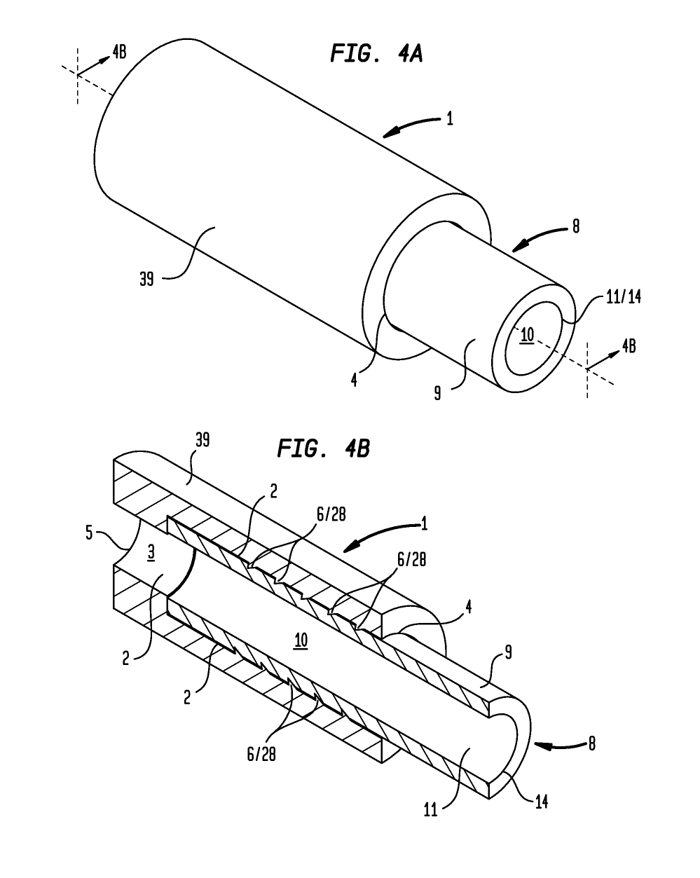

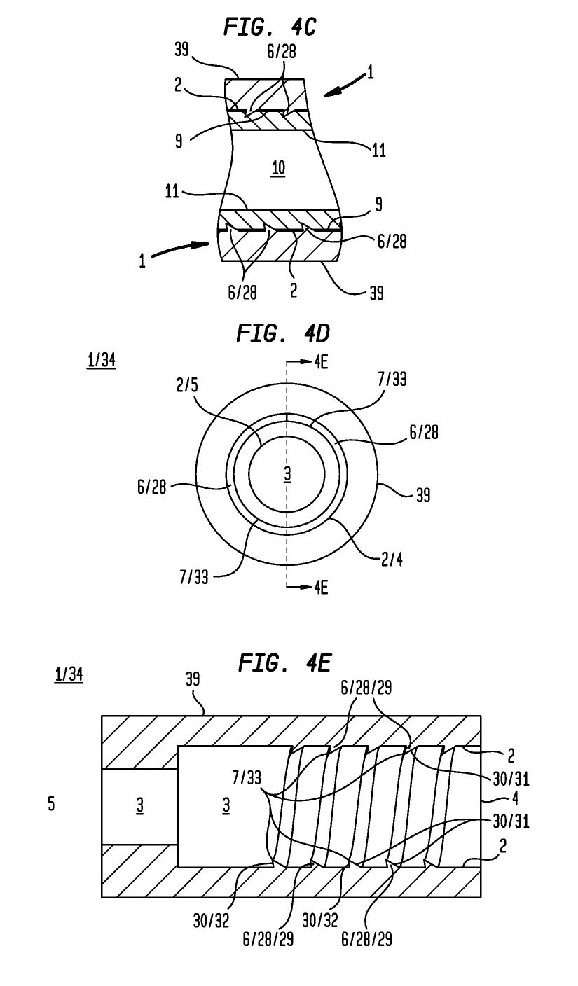

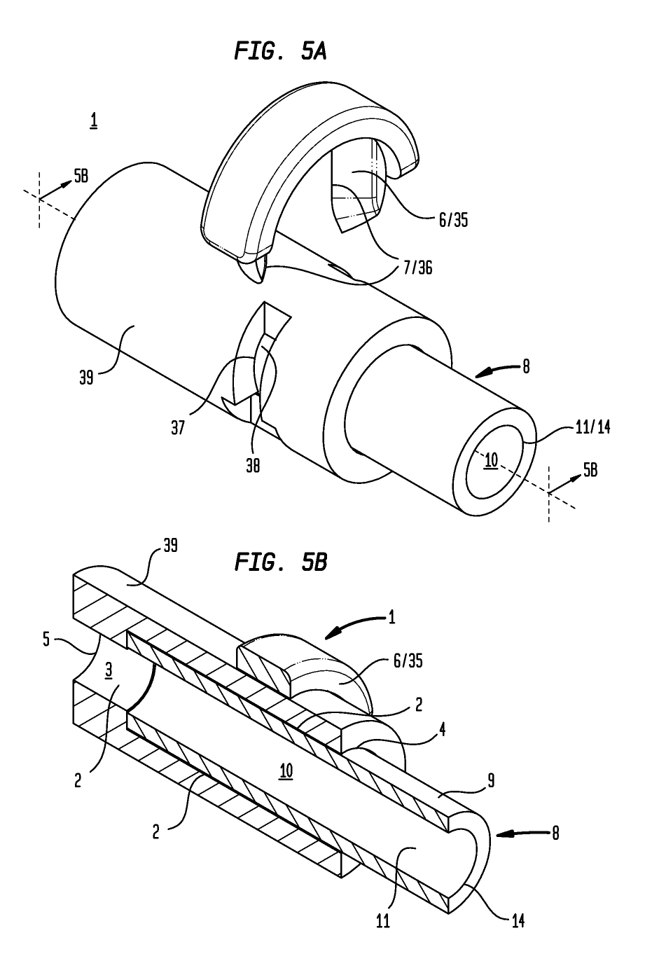

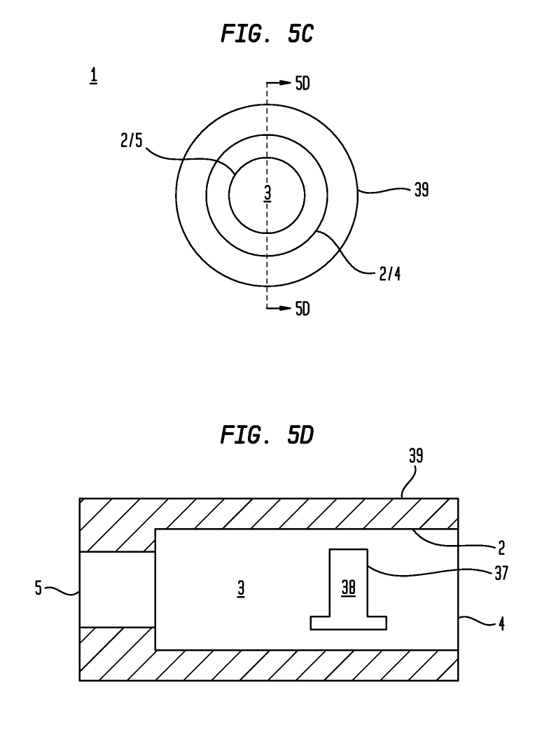

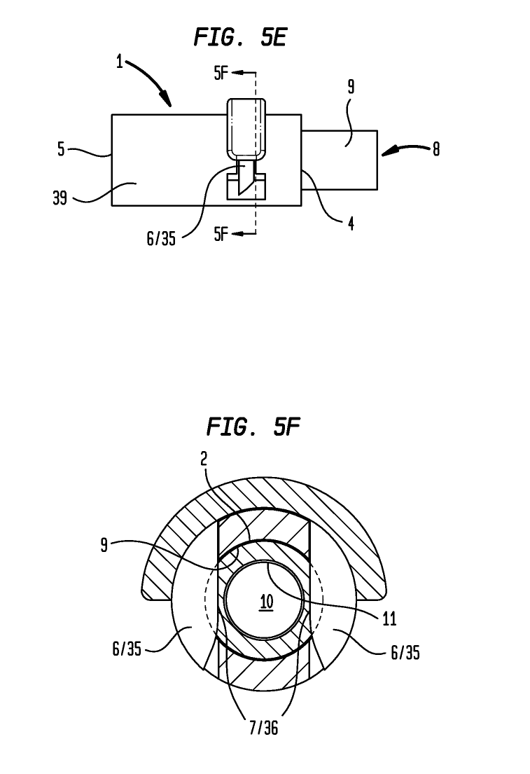

Now referring primarily to FIG. 2B through FIG. 2E, FIG. 3B through FIG. 3F, FIG. 4B through FIG. 4E, FIG. 5B through FIG. 5D, and FIG. 5F, the connector (1) includes a tubular inner surface (2) which defines a connector passageway (3) communicating between connector first and second open ends (4)(5), whereby the tubular inner surface (2) can be configured in any of a numerous and wide variety of configurations having varying dimensions to provide a connector passageway (3) capable of insertingly receiving a correspondingly numerous and wide variety of configurations of conduits (8).

As but one illustrative example, the tubular inner surface (2) can be configured to define a connector passageway (3) having a generally circular cross section, which can correspondingly insertingly receive a conduit (8) having a generally circular cross section.

Again referring primarily to FIG. 2B through FIG. 2E, FIG. 3B through FIG. 3F, FIG. 4B through FIG. 4E, FIG. 5B through FIG. 5D, and FIG. 5F, the connector (1) further includes a barb (6) inwardly extending from the tubular inner surface (2) into the connector passageway (3) proximate the connector first open end (4), whereby the barb (6) terminates in a barb tip (7) which disposes away from the connector first open end (4). As described above, the barb tip (7) is configured to engage with a conduit external surface (9) of a conduit (8) inserted into the connector first open end (4) for receipt within the connector passageway (3).

The term “barb” for the purposes of the present invention means a protrusion having a tip which extends in a first direction to preclude extraction in a second direction which opposes the first direction. Typically, the barb tip (7) disposes in oblique relation to the tubular inner surface (2) of the connector (1) having the barb (6).

Now referring primarily to FIG. 2A through FIG. 2E, as to particular embodiments, the connector (1) can, but need not necessarily, further include a plurality of discrete barbs (19) inwardly extending from the tubular inner surface (2) into the connector passageway (3) proximate the connector first open end (4), whereby each discrete barb (19) terminates in a discrete barb tip (20) which disposes away from the connector first open end (4). As but one illustrative example, the plurality of discrete barbs (19) can be disposed in circumferentially spaced apart relation, although the invention need not be limited to this configuration.

Now referring primarily to FIG. 3A through FIG. 3F, as to other particular embodiments, the connector (1) can, but need not necessarily, include a barb (6) configured as an annular barb (21) which circumferentially extends about the tubular inner surface (2).

As to these particular embodiments, the annular barb (21) can be defined by a plurality of annular barb side walls (22), such as annular barb first and second side walls (23)(24), which inwardly taper to an annular barb tip (25). The annular barb side walls (22) can be linear, arcuate, or combinations thereof, and can have any of a numerous and wide variety of dimensions which inwardly taper to provide the annular barb tip (25) which disposes away from the connector first open end (4).

As but one illustrative example, the annular barb (21) can be defined by an annular barb first side wall (23) having a greater side wall length and disposing at a lesser angle (26) in relation to a longitudinal axis (27) of the connector passageway (3) (for example, an angle of) 30° relative to an annular barb second side wall (24), which has a lesser side wall length and disposes at a greater angle (26) in relation to the longitudinal axis (27) of the connector passageway (3) (for example, an angle of 60°), thereby providing an annular barb tip (25) which disposes away from the connector first open end (4) (as shown in the example of FIG. 3F).

Now referring primarily to FIG. 4A through FIG. 4E, as to yet other particular embodiments, the connector (1) can, but need not necessarily, include a barb (6) configured as a helical barb (28) which helically extends about the tubular inner surface (2), whereby the helical barb (28) can have one turn (29), or a plurality of turns (29) disposed in spaced apart relation, depending upon the application.

The helical barb (28) can be defined by a plurality of helical barb side walls (30), such as helical barb first and second side walls (31)(32), which inwardly taper to a helical barb tip (33), whereby the helical barb side walls (30) can be configured as described above for the annual barb side walls (22) of the annular barb (21).

Now referring primarily to FIG. 2A through FIG. 4E, as particular embodiments, the connecter (1) can, but need not necessarily, include a tubular inner surface (2) and a barb (6) (whether a discrete barb (19), an annular barb (21), or a helical barb (28)) which are formed as a one-piece construct (34) or a unitary construct.

Now referring primarily to FIG. 5A through FIG. 5F, as to still yet other particular embodiments, the connector (1) can, but need not necessarily, include a barb (6) configured as an couplable barb (35) capable of coupling to the connector (1) to inwardly extend from the tubular inner surface (2) into the connector passageway (3) proximate the connector first open end (4), the couplable barb (35) terminating in a couplable barb tip (36) which disposes away from the connector first open end (4).

Again referring primarily to FIG. 5A through FIG. 5F, the connector (1) can, but need not necessarily, further include at least one aperture element (37) which defines an aperture element opening (38) communicating between a connector outer surface (39) and the connector passageway (3), whereby the aperture element opening (38) is configured to receive the couplable barb (35) which, upon receipt, inwardly extends from the tubular inner surface (2) into the connector passageway (3) proximate the connector first open end (4).

As but one illustrative example, the couplable barb (35) can slidably engage with the connector (1), whereby upon slidable engagement, the couplable barb (35) is received within the aperture element opening (38) to inwardly extend from the tubular inner surface (2) into the connector passageway (3) proximate the connector first open end (4). However, the invention need not be limited to slidable engagement.

Yet again referring primarily to FIG. 5A through FIG. 5F, the couplable barb tip (35) can be configured to penetrate a conduit external surface (9) of a conduit (8) received within the connector passageway (3) to fixedly secure the conduit (8) within the connector passageway (3), precluding the conduit (8) from egressing from the connector first open end (4) of the connector (1).

Now referring primarily to FIG. 1 through FIG. 5F, the connector (1) further includes a connector outer surface (39) (shown in broken line) which can be configured in any of a numerous and wide variety of configurations having varying dimensions, whereby a connector outer surface (39) proximate the connector second open end (5) can be capable of coupling or matably coupling to an apparatus (16), which can have a correspondingly numerous and wide variety of configurations.

As but one illustrative example, the connector outer surface (39) proximate the connector second open end (5) can include spiral threads configured to matably engage with corresponding spiral threads disposed about an apparatus (16), such as a medical syringe barrel, upon rotational engagement of the medical syringe barrel with the connector (1).

As to particular embodiments, the connector (1) can, but need not necessarily, further include one or more flange elements coupled to the connector outer surface (39), whereby the flange elements can facilitate gripping of the connector (1) to forcibly urge coupling of the connector (1) with a conduit (8), an apparatus (16), or combinations thereof.

A method of making a particular embodiment of the connector (1) includes providing a tubular inner surface (2) defining a connector passageway (3) which communicates between connector first and second open ends (4)(5); inwardly extending a barb (6) from the tubular inner surface (2) into the connector passageway (3) proximate the connector first open end (4), the barb (6) terminating in a barb tip (7); and disposing the barb tip (7) away from the connector first open end (4). The barb tip (7) is configured to engage with a conduit external surface (9) of a conduit (8) inserted into the connector first open end (4) for receipt within the connector passageway (3).

The method of making the connector (1) can, but need not necessarily, further include inwardly extending a plurality of discrete barbs (19) from the tubular inner surface (2) into the connector passageway (3) proximate the connector first open end (4), each discrete barb (19) terminating in a discrete barb tip (20); and disposing each discrete barb tip (19) away from the connector first open end (4). As to particular embodiments, the method of making the connector (1) can, but need not necessarily, further include disposing the plurality of discrete barbs (19) in circumferentially spaced apart relation.

The method of making the connector (1) can, but need not necessarily, further include configuring the barb (6) as an annular barb (21) circumferentially extending about the tubular inner surface (2).

The method of making the connector (1) can, but need not necessarily, further include configuring the barb (6) as a helical barb (28) helically extending about the tubular inner surface (2).

The method of making the connector (1) can, but need not necessarily, further include forming the tubular inner surface (2) and the barb (6) as a one-piece construct. As to particular embodiments, the tubular inner surface (2) and the barb (6) can be formed as a one-piece construct by injection molding.

However, the method of making the connector (1) need not be limited to injection molding, as particular embodiments of the connector (1) can be formed by other methods, such as compression molding, extrusion molding, fabrication, machining, printing, additive printing, three-dimensional printing, or the like, or combinations thereof, as a one-piece construct or a unitary construct.

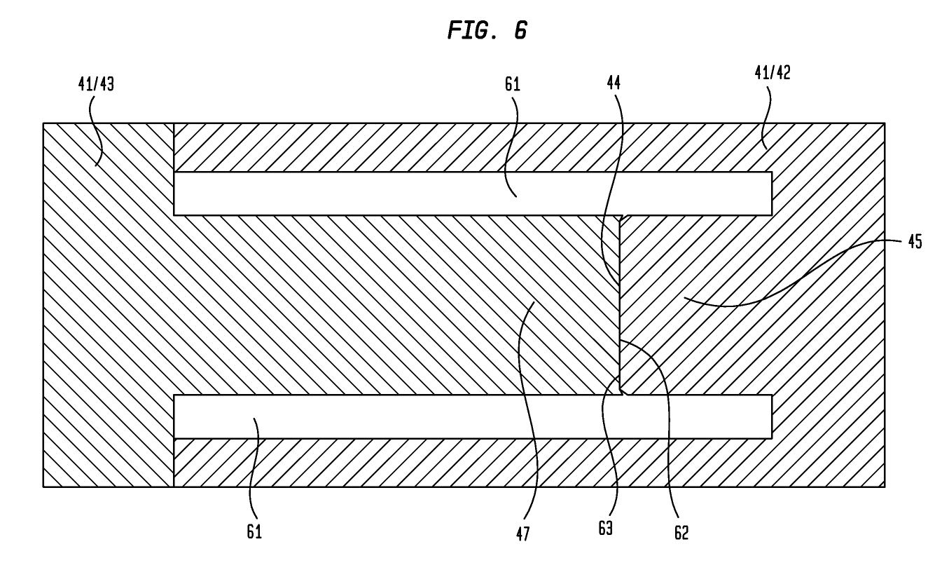

Now referring primarily to FIG. 6, as to particular embodiments of the connector (1) having the tubular inner surface (2) and the barb (6) formed as a one-piece construct (34) by injection molding, the connector (1) can be formed using a mold (41) having mold first and second parts (42)(43) which adjacently engage at a juncture (44) corresponding to the barb tip (7) of the connector (1) generated from the mold (41).

Again referring primarily to FIG. 6, the mold first part (42) can include a first pin (45) configured to define a tubular inner surface first portion (46) which disposes between the connector first open end (4) and the barb tip (7) of the connector (1) generated from the mold (41).

Again referring primarily to FIG. 6, the mold second part (43) can include a second pin (47) configured to define a tubular inner surface second portion (48) which disposes between the connector second open end (5) and the barb tip (7) of the connector (1) generated from the mold (41).

The connector (1) can be made any of a numerous and wide variety of materials, including polymeric material (49) or resin (50), which can include as non-limiting examples:

thermoplastics, such as acrylic, nylon, polybenzimidazole, polyethylene, polypropylene, polystyrene, polyvinyl chloride, polytetrafluoroethylene, or the like; thermosets, such as polyester fiberglass, polyurethanes, rubber, polyoxybenzylmethylenglycolanhydride, urea-formaldehyde foam, melamine resin, epoxy resin, polyimides, cynate esters, polycyanurates, polyester resin, or the like; elastomers, such as natural polyisoprene, synthetic polyisoprene, polybutadiene, chloropene rubber, butyl rubber, styrene-butadiene rubber, nitrile rubber, ethylene propylene rubber, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, thermal plastic elastomer (TPE), or the like, or combinations thereof.

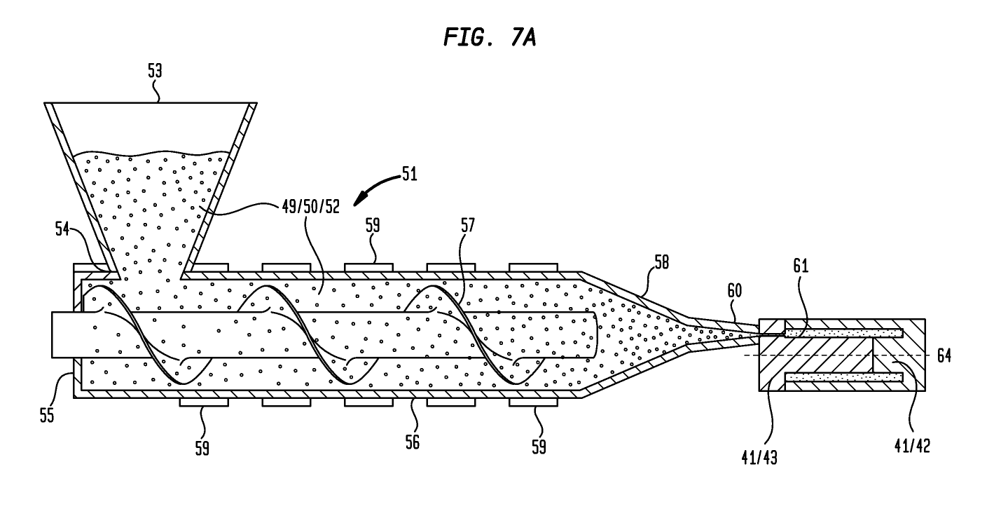

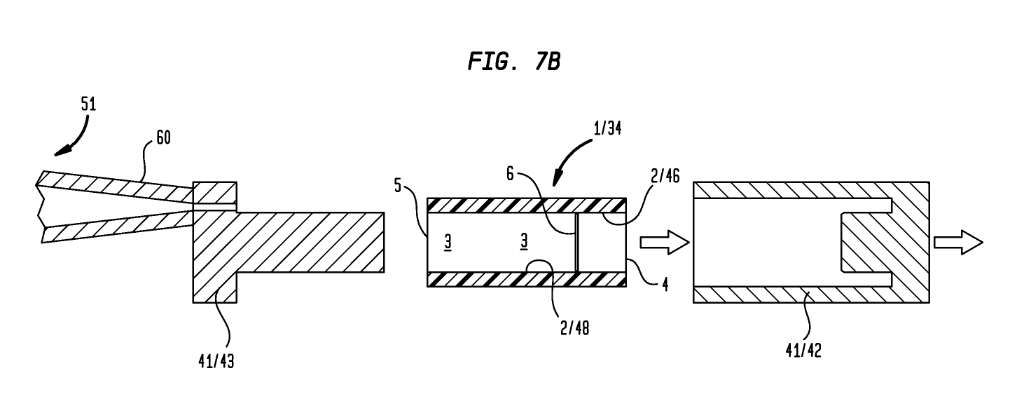

Now referring primarily to FIG. 7A and FIG. 7B, the connector (1) can be made from one or more polymeric materials (49) or resins (50) using an injection molder (51). The polymeric material (49) or resin (50) can be provided in the form of nurdles (52) which generally take the form of small granules or beads. As to particular embodiments, the polymeric material (49) or resin (50) can further include additives, such as plasticizers, fillers, pigments, colorants, or ultraviolet radiation inhibitors, which can be added during production of the polymer or can be provided as a liquid(s) or as a solid(s) which can be combined with the nurdles (52).

Again referring primarily to FIG. 7A and FIG. 7B, the nurdles (52) can be disposed in a hopper (53) and fed under influence of gravity through a feed throat (54) of the hopper (53) proximate a barrel rear end (55) of a barrel (56). A screw (57) rotatably journaled in the barrel (56) can contact the nurdles (52) entering the barrel rear end (55). A driver can operate to rotate the screw (57) inside the barrel (56), forcibly urging the nurdles (52) toward a barrel front end (58).

Now referring primarily to FIG. 7A, a heater (59) can be coupled to the barrel (56) to heat the barrel (56) to a desired temperature. One or more temperature sensors can be disposed in relation to the barrel (56) to control temperature along the length of the barrel (56). The temperature along the barrel (56) can be controlled to achieve the melt point of the nurdles (52) (the temperature at which the nurdles (52) begin to turn from a solid to a liquid also referred to as “molten polymeric material”). The melt point varies greatly between different polymeric materials (49) or resins (50) but typically occurs within a range from about 170° C. (338° F.) to about 275° C. (527° F.); however, the invention need not be so limited, as particular polymeric materials (49) or resins (50) may have a melt point which occurs at a lesser or greater temperature.

As to particular embodiments, a heating profile can be set for the barrel (56) in which one or more temperature-controlled heater zones gradually increase the temperature of the barrel (56) from the barrel rear end (55) to the barrel front end (58). This allows the nurdles (52) of polymeric material (49) or resin (50) to melt gradually as they are forced along the length of the barrel (56) toward the barrel front end (58).

The screw (57) acting on the nurdles (52) generates an amount of pressure and friction which can generate an additional amount of heat. The heat of pressure and friction can be sufficient to achieve or maintain the melt point of the polymeric material (49) or resin (50) inside the barrel (56). The injection molder (51) can further include cooling elements, such as fans or water jackets, to maintain the temperature at or below a temperature set point.

Now referring primarily to FIG. 7A and FIG. 7B, at the barrel front end (58), molten polymeric material (49) or resin (50) can egress from the barrel (56) through a nozzle (60) and into a mold cavity (61) of the mold (41) including the mold first part (42) and the mold second part (43) disposed such that the mold parts (42)(43) adjacently engage at the juncture (44), thereby adjacently engaging a first pin second end (62) with a second pin first end (63). Following, the molten polymeric material (49) or resin (50) can cool and solidify within the mold cavity (61). Subsequently, the mold first and second parts (42)(43) can be separated by moving the mold first and second parts (42)(43) away from one another in opposing directions along a mold longitudinal axis (64). As such, the connector (1) can be produced as a one-piece construct (34) having a tubular inner surface (2) defining a connector passageway (3) which communicates between connector first and second open ends (4)(5) and a barb (6) inwardly extending from the tubular inner surface (2) into the connector passageway (3) proximate the connector first open end (4), the barb (6) terminating in a barb tip (7) which disposes away from the connector first open end (4).

The method of making the connector (1) can, but need not necessarily, further include configuring the barb (6) as a couplable barb (35) capable of coupling to the connector (1) to inwardly extend from the tubular inner surface (2) into the connector passageway (3) proximate the connector first open end (4), the couplable barb (35) terminating in a couplable barb tip (36); and disposing the couplable barb tip (36) away from the connector first open end (4).

The method of making the connector (1) can, but need not necessarily, further include disposing at least one aperture element (37) in the connector (1), the aperture element (37) defining an aperture element opening (38) which communicates between a connector outer surface (39) and the connector passageway (3); whereby the aperture element opening (38) is configured to receive the couplable barb (35).

The method of making the connector (1) can, but need not necessarily, further include configuring the couplable barb tip (36) to penetrate a conduit external surface (9) of the conduit (8) received within the connector passageway (3).

A method of using the connector (1) to connect to a conduit (8) includes obtaining the connector (1) and fixedly securing the conduit (8) within the connector passageway (3), as described above. Following, the method can further include flowing fluid (13) through the fluid flow path (12), also as described above.

The method of using the connector (1) to connect to a conduit (8) can, but need not necessarily, further include coupling an apparatus (16) to the connector (1), as described above. Subsequently, the method can further include flowing fluid (13) through the fluid flow path (12), also as described above.

As can be easily understood from the foregoing, the basic concepts of the present invention may be embodied in a variety of ways. The invention involves numerous and varied embodiments of a connector having a tubular inner surface barb and methods for making and using such connectors having a tubular inner surface barb, including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “connector” should be understood to encompass disclosure of the act of “connecting”—whether explicitly discussed or not—and, conversely, were there effectively disclosure of the act of “connecting”, such a disclosure should be understood to encompass disclosure of a “connector” and even a “means for connecting”. Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the connectors having a tubular inner surface barb herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A connector comprising:
a tubular inner surface defining a connector passageway which communicates between connector first and second open ends; and
a barb inwardly extending from said tubular inner surface into said connector passageway proximate said connector first open end, said barb terminating in a barb tip which disposes away from said connector first open end.

2. The connector of claim 1, wherein said barb tip is configured to engage with a conduit external surface of a conduit inserted into said connector first open end for receipt within said connector passageway.

3. The connector of claim 2, further comprising a plurality of discrete barbs inwardly extending from said tubular inner surface into said connector passageway proximate said connector first open end, each said discrete barb terminating in a discrete barb tip which disposes away from said connector first open end.

4. The connector of claim 3, wherein said plurality of discrete barbs are disposed in circumferentially spaced apart relation.

5. The connector of claim 2, wherein said barb is configured as an annular barb circumferentially extending about said tubular inner surface.

6. The connector of claim 2, wherein said barb is configured as a helical barb helically extending about said tubular inner surface.

7. The connector of claim 2, wherein said tubular inner surface and said barb are formed as a one-piece construct.

8. The connector of claim 7, wherein said tubular inner surface and said barb are formed as said one-piece construct by injection molding.

9. The connector of claim 8, wherein said tubular inner surface and said barb are formed as said one-piece construct by injection molding using a mold having mold first and second parts which adjacently engage at a juncture corresponding to said barb tip of said connector generated from said mold.

10. The connector of claim 9, wherein said mold first part comprises a first pin configured to define a tubular inner surface first portion which disposes between said connector first open end and said barb tip of said connector generated from said mold.

11. The connector of claim 10, wherein said mold second part comprises a second pin configured to define a tubular inner surface second portion which disposes between said connector second open end and said barb tip of said connector generated from said mold.

12. The connector of claim 2, wherein said barb is configured as a couplable barb capable of coupling to said connector to inwardly extend from said tubular inner surface into said connector passageway proximate said connector first open end, said couplable barb terminating in a couplable barb tip which disposes away from said connector first open end.

13. The connector of claim 12, wherein said connector further comprises at least one aperture element which defines an aperture element opening communicating between a connector outer surface and said connector passageway, said aperture element opening configured to receive said couplable barb.

14. The connector of claim 13, wherein said couplable barb tip is configured to penetrate a conduit external surface of said conduit received within said connector passageway.

15. A method of making a connector, said method comprising:
providing a tubular inner surface defining a connector passageway which communicates between connector first and second open ends;
inwardly extending a barb from said tubular inner surface into said connector passageway proximate said connector first open end, said barb terminating in a barb tip; and
disposing said barb tip away from said connector first open end.

16. The method of claim 15, wherein said barb tip is configured to engage with a conduit external surface of a conduit inserted into said connector first open end for receipt within said connector passageway.

17. The method of claim 16, further comprising:
inwardly extending a plurality of discrete barbs from said tubular inner surface into said connector passageway proximate said connector first open end, each said discrete barb terminating in a discrete barb tip; and
disposing each said discrete barb tip away from said connector first open end.

18. (canceled)

19. The method of claim 16, further comprising configuring said barb as an annular barb circumferentially extending about said tubular inner surface.

20. The method of claim 16, further comprising configuring said barb as a helical barb helically extending about said tubular inner surface.

21. The method of claim 16, further comprising forming said tubular inner surface and said barb as a one-piece construct.

22-35. (canceled)
